(19) United States
(12) Patent Application Publication
(10) Pub. No.: US 2018/0314699 A1
(43) Pub. Date: Nov. 1, 2018

(54) CALCULATING USER INFLUENTIAL SCORE IN SOCIAL PROPERTY

(71) Applicant: Google Inc., Mountain View, CA (US)

(72) Inventors: Xiaofeng GUO, Fremont, CA (US); Tong Liu, Sunnyvale, CA (US)

(73) Assignee: Google Inc., Mountain View, CA (US)

(21) Appl. No.: 14/080,737

(22) Filed: Nov. 14, 2013

(51) Int. Cl. G06F 17/30

(52) U.S. Cl. CPC G06F 17/3053

(57) ABSTRACT

In one aspect, a method and system are provided for determining influential users with respect to a social property. The method may include identifying a plurality of users associated with a social property, for each of the plurality of users determining an influence score for the user with respect to the social property, wherein the influence score for the user is defined with respect to one or more social activity of the user and one or more contacts of the user with respect to the social property, determining a set of users of the plurality of users, the set of users including one or more users, having an influence score that meets a condition indicating that the user is an influential user and providing an indication of the set of users being influential users for display.

### BACKGROUND

As social networking becomes an important marketing and communication tool for various individuals, brands and organizations, it becomes more important to measure the influence of various users on the social networking space. A user (or other profile holder) may have an influence measurable through the activity and connections of the user across one or more social networking services and with respect to various social networking profiles, or content.

### SUMMARY

The disclosed subject matter relates to a machine-implemented method for determining influential users with respect to a social property, the method comprising identifying a plurality of users associated with a social property. The method may further comprise for each of the plurality of users determining an influence score for the user with respect to the social property, wherein the influence score for the user is defined with respect to one or more social activity of the user and one or more contacts of the user with respect to the social property. The method may further comprise determining a set of users of the plurality of users, the set of users including one or more users, having an influence score that meets a condition indicating that the user is an influential user and providing an indication of the set of users being influential users for display. Other aspects can be embodied in corresponding systems and apparatus, including computer program products.

The disclosed subject matter also relates to a system for determining influential users with respect to a social property, the system comprising one or more processors and a machine-readable medium comprising instructions stored therein, which when executed by the processors, cause the processors to perform operations comprising identifying a plurality of users associated with a social property. The operations may further comprise for each of the plurality of users determining an influence score for the user with respect to the social property, wherein the influence score for the user is defined with respect to one or more social activity of the user and one or more contacts of the user with respect to the social property, the user influence score being defined in terms of one or more feature components, each feature component referring to a specific type of social activity. The operations may further comprise determining a set of influential users of the plurality of users, the set of influential users including one or more users having an influence score that meets a condition indicating that the user is an influential user. The operations may further comprise providing an indication identifying the set of influential users for display.

The disclosed subject matter also relates to a machine-readable medium including instructions stored therein, which when executed by a machine, cause the machine to perform operations comprising identifying a plurality of users associated with a social property. The operations may further comprise for each of the plurality of users determining an influence score for the user with respect to the social property, wherein the influence score for the user is defined with respect to one or more social activity of the user and one or more contacts of the user with respect to the social property, the influence score being defined in terms of one or more feature components, each feature component referring to a specific type of social activity. The operations may further comprise normalizing the influence score for each of the plurality of users. The operations may further comprise clustering the plurality of users into two sets according to the normalized influence score for each of the plurality of users. The operations may further comprise determining a first set of the two sets of clusters as a set of influential users of the plurality of users according to the clustering and providing an indication that the set of influential users are influential users.

It is understood that other configurations of the subject technology will become readily apparent from the following detailed description, where various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several implementations of the subject technology are set forth in the following figures.

FIG. 1 illustrates an example client-server network environment, which provides for calculating an influential score for one or more users to identify influential users with respect to a social property.

FIG. 2 illustrates a flow diagram of an example process for identifying influential users with respect to a social property.

FIGS. 3 and 4 illustrate an example graphical user interface displaying influential user information with respect to a social property.

FIG. 5 conceptually illustrates an electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent that the subject technology is not limited to the specific details set forth herein and may be practiced without these specific details.

The present disclosure provides a method and system for calculating an influential score for users and identifying influential users with respect to a social property. A “social property” may refer to content, including, for example, one or more profiles, pages, one or more posts within one or more pages, a collection of pages, posts or other social content owner by, or relating to a social entity. The term “social entity” as used herein may refer to an individual, brand, business, affiliation, organization, group, or category. In one example, the social property and/or social entity may be defined using a set of criteria including one or more keywords or other identifiers. Various users (e.g., a social networking profile owner or operator) may be associated with a social property by subscribing to the property, being identified as a contact, or taking action (e.g., social activity) with respect to the property.

In one example, a score is calculated for one or more users associated with the social property. In some implementations, data from various social networking services regarding associated users is collected. The data may be collected from across the web and may include data generated at or shared within one or more social networking services in which the user is associated with a profile or account. The collected data may include the social activity of the user across the one or more social networking services and/or in association with the user social networking account or profile outside the social networking service and/or associations of the user at the one or more social networking services. In one example, the collected data is updated as data becomes available at the one or more social networking services. In one example, the collection of data may be updated upon a request, periodically or on a continuous basis. In one example, the data collection may occur according to a push mechanism, a pull mechanism and/or a combination thereof.

For each user, in one implementation, a social graph is generated from the collected data. The social graph may for example be generated according to social graph data available at the one or more social networking services. In some examples, the social graph may be based on user activity at one or more social networking services, and or in association with social networking profile or account of the user at one or more websites or applications. In one example, the data may be specifically collected with respect to a specific social property or may be filtered to retrieve data relating to a specific social property.

The collected data is then used to generate a score for the user based on the social activity and connections of the user across one or more social networking services. In one example, each user is associated with an initial score (e.g., a score of 1). The user score is updated iteratively (e.g., according to a request, an event or periodically). In one example, the updated score is based on updated data collected for the user. The updated user score is propagated to the contacts of the user according to the social graph.

In one example, the user influential score is determined with respect to different features representing different types of social activity. For each feature, a user to user relationship is defined, and the score of each user is impacted by the relationship. In one example, each feature may be constrained by its feature parameter.

The calculated scores may be used to surface influential users. In one example, the scores may be clustered (e.g., using the simple K-means algorithm) to determine the most influential users for the social property. In one example, scores for each user may be provided for display. In another example, the scores may be used to identify the most influential users. The determination may be used to surface activity from the most influential users for the social property. In one example, the influential score of the users and/or an indication of a user being influential may be used to filter influential users according to a request.

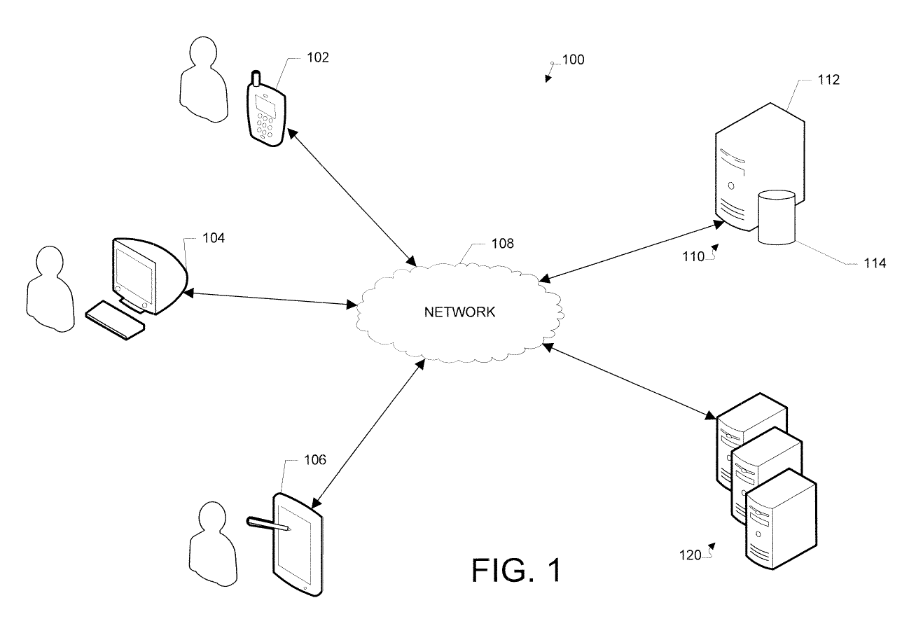

FIG. 1 illustrates an example client-server network environment, which provides for calculating an influential score for one or more users to identify influential users with respect to a social property. A network environment 100 includes a number of electronic devices 102, 104, 106 communicably connected to a server 110 and remote servers 120 by a network 108. Network 108 can be a public communication network (e.g., the Internet, cellular data network, dialup modems over a telephone network) or a private communications network (e.g., private LAN, leased lines). Further, network 108 can include, but is not limited to, any one or more of the following network topologies, including a bus network, a star network, a ring network, a mesh network, a star-bus network, a tree or hierarchical network, and the like.

In some example implementations, electronic devices 102, 104, 106 can be computing devices such as laptop or desktop computers, smartphones, PDAs, portable media players, tablet computers, or other appropriate computing devices. In the example of FIG. 1, electronic device 102 is depicted as a smartphone, electronic device 104 is depicted as a desktop computer and electronic device 106 is depicted as a PDA.

Communications between the client devices 102, 104, 106, server 110 and/or one or more remote servers 120 may be facilitated through various communication protocols. In some aspects, client devices 102, 104, 106 may communicate wirelessly through a communication interface (not shown), which may include digital signal processing circuitry where necessary.

The communication interface may provide for communications under various modes or protocols, including Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, or General Packet Radio System (GPRS), among others. For example, the communication may occur through a radio-frequency transceiver (not shown). In addition, short-range communication may occur, including using a Bluetooth, WiFi, or other such transceiver.

In some implementations, server 110 includes a processing device 112 and a data store 114. Processing device 112 executes computer instructions stored in data store 114, for example, to facilitate calculating an influential score associated with users interacting with electronic devices 102, 104, 106 and identifying influential users with respect to a social property. Server 110 may further be in communication with remote servers 120 either through the network 108 or through another network or communication means.

In one example, remote servers 120 may perform various functionalities and/or storage capabilities described herein with regard to the server 110 either alone or in combination with server 110. Server 110 may further maintain or be in communication with social networking services hosted on one or more remote server 120. The one or more social networking services may provide various services and may enable users to create a profile and associate themselves with other users at one or more remote social networking services. The server 110 and/or the one or more remote servers 120 may further facilitate the generation and maintenance of one or more social graphs including the user created associations. The social graphs may include, for example, a list of all users of the remote social networking service(s) and their associations with other users of a remote social networking service(s).

In some example aspects, server 110 and/or one or more remote servers 120 can be a single computing device such as a computer server. In other implementations, server 110 and/or one or more remote servers 120 can represent more than one computing device working together to perform the actions of a server computer (e.g., cloud computing). Server 110 and/or one or more remote servers 120 may be coupled with various remote databases or storage services. While server 110 and the one or more remote servers 120 are displayed as being remote from one another, it should be understood that the functions performed by these servers may be performed within a single server, or across multiple servers.

Users may interact with the system hosted by server 110, and/or one or more social networking services hosted by remote servers 120, through a client application installed at the electronic devices 102, 104, 106. Alternatively, the user may interact with the system and the one or more social networking services through a web based browser application at the electronic devices 102, 104, 106. Communication between client devices 102, 104, 106 and the system, and/or one or more social networking services, may be facilitated through a network (e.g., network 108).

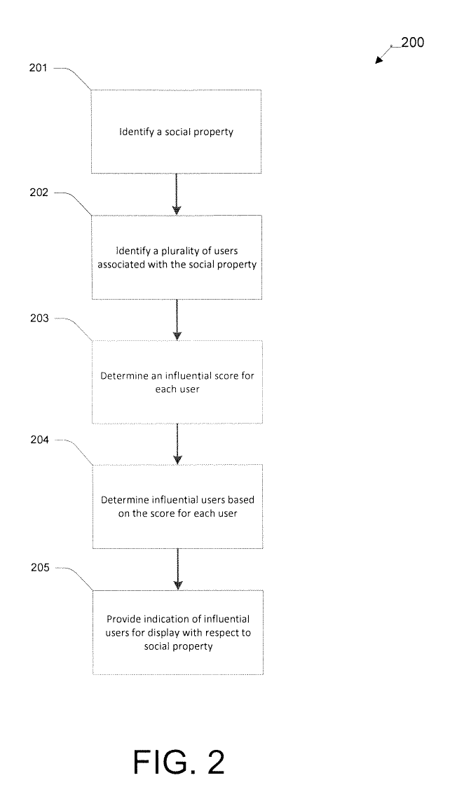

FIG. 2 illustrates a flow diagram of an example process 200 for identifying influential users with respect to a social property. In one example, the process may be performed by a system or application (e.g., hosted by server 110). In step 202, a social property is identified. As described above, a social property may refer to content owned by any individual, business, organization, brand or group. In one example, the social property may be associated with various profile(s), account(s), content, websites, key terms, or other identifiers indicating that content or activity is associated with the social property. In one example, any collection of content may be defined as a social property according to various identifiers or criteria defining the social property. For example, a social property may refer to a business, brand, category of business, product, product category, organization, or other grouping of goods or ideas. In one example, an owner of a social property (e.g., a social entity), may be interested in information regarding the influence of users with respect to the social property or across one or more social properties. A social property may be defined according to the interest of a user requesting information regarding influential users.

In step 202, a plurality of users associated with the social property are identified. In one example, a user is identified as being associated with the social property if the user has taken an action with respect to the social property, including, for example, subscribing to the social property or a profile or account associated with the social property, indicating an association with the social property, or performed one or more social activity with respect to the social property.

In step 203, an influential score is determined with respect to one or more users identified in step 203. In one example, the influential score for each user is calculated iteratively, and is based on the user social activity and/or user social affiliations and connections. In one example, the influential score of the user may be defined based on a combination of social activity performed by the user with respect to the social property and/or social activity of contacts of the user with respect to the social property. For example, in step 203, data collected across various social media is used to generate a social graph for each user. Each user is provided with an initial score (e.g., 1). The collected data across one or more social networking services is used at each iteration to calculate an updated score (Sₙ) for the user. In one example, the user's score is then propagated to their connections (e.g., according to the generated social graph).

In one example, the score is feature extendible. Each feature of the score may relate to a different type of social activity (e.g., endorsement, comment, share, post, reshare, etc.) or a combination of social activities resulting from one another. For each feature, based on a relationship for two users, the score for one user may be impacted by the relationship.

In one example, for each user, the score for each iteration is calculated according to the following:

Sₙ=normalize(Sₙ₋₁+αₙASₙ₋₁+βₙBSₙ₋₁+ . . . ) (1)

Where Sₙ is the score for each iteration. In one example, the score is based upon the previous score of the user and/or previous scores for each of the user's connections. In one example, the initial score S₀ is set to 1 according to the following:

S₀=(1,1,1, . . . ,1) (2)

In one implementation, each component of the score (e.g., αₙASₙ₋₁, βₙBSₙ₋₁, . . . ) defines a different feature of the score.

Each feature may be constrained by a feature parameter (αₙ, βₙ, . . . ). A feature parameter may define a weight or importance of the feature. In one example, the feature may thus be adjusted for a certain result. For each feature parameter (e.g., α₀) a decay function ƒ(n) may be applied to the feature parameter such that αₙ=α₀ƒ(n) to ensure that after enough iterations the score converges. For example, ƒ(n) may be defined as 1/√(n−1). In another embodiment, α₀ may be used without a decay function, when it is proven that the score is convergent with ƒ(n)=1.

In some implementations, each feature component includes a feature matrix (e.g., A, B, . . . ), defines the feature in terms of users and user relationships. Values for the elements of the matrix may be set depending on the specific features being expressed by the matrix.

In some examples, for some features (e.g., comments, endorsements, etc.), a corresponding matrix may be generated (e.g., A, B, . . . ) to define the feature relationship between users. For example, a first feature may be defined based on matrix A, where each element in A represents a relationship from one user to another user (e.g., a weighted relationship). For example, Aᵢⱼ of vector A represents the weighted relationship of the feature from user i to user j. For example, the feature or social activity represented by matrix A may be comments. Where user j comments t times with respect to user i (described as j→i), the value of Aᵢⱼ may be set to t. In addition for those comments, where user j has p outcome comments (e.g., j comments on p users), Aᵢⱼ may be set to t/p. In this manner, user i gets a contribution of t/p to its score (e.g., t/p multiplied to score of user j) from user j. In one example, this may express page ranking (e.g., ranking of content in search results or queries) in the scoring formula.

In some examples, with respect to certain features (e.g., posts, shares) the matrix may represent self activities, and thus elements of the matrix may represent an activity of the user with respect to itself (e.g., i→i). For example, for social activities such as posts and/or shares, for all elements where i is not equal to j, the value may be set to 0. In another example, for social activities, such as posts and/or shares, Aᵢᵢ may be set to the number of posts and/or shares of the user i. In general, a matrix may be used to describe any type of relationship between users (e.g., two users) or for activity of a user and may be extended to various features.

The normalization of the score during each iteration may be performed in various embodiments to ensure convergence of the score. In other embodiments, normalization may not be performed and convergence may be achieved otherwise. Score normalization may be performed according to a normalization function. For example, in one example, normalization may be performed by standard deviation. In another example, normalization may be performed by using the minimum or maximum function. In some examples, the normalization function changes vector X (e.g., set to (Sₙ₋₁+αₙASₙ₋₁+βₙBSₙ₋₁+ . . . )) according to the function:

∀i,X′ᵢ=Xᵢ−a/b (3)

For normalization by standard deviation, a is set to X̅ b is set to X̅² according to the following formulas:

X̅=ΣᵢXᵢ/n (4)

X̅²=Σᵢ(Xᵢ₋X̅)²/n−1 (5)

In another example, for normalization, a is set to min(X), and b is set to max(X)−min(X). The additional benefit of this method of normalization is that the result is always in [0,1).

In one example, convergence of the score may be checked according to an error calculated for the score, where the error is calculated as:

Eₙ=|Sₙ−Sₙ₋₁| (6)

Once the score (Sₙ) is calculated for each user, the process continues to step 204. In one example, after calculating the scores for each user, the scores may be provided for display with respect to the social property. In step 204, influential users are determined based on the calculated score for each user. In one example, a cut off is determined to define users as influential with respect to a social property based on their influential score. In one example, the cut off may be defined based on a threshold value determined according to various techniques. In some examples, a fixed value may be used as the cut off threshold. In other examples, clustering may be used to cluster users into one or more clusters to define a cut off of influential scores (users) with respect to a social property. In one example, the user scores may be clustered into at least two sets, with a set defining the influential users.

In some implementations, a K-means clustering algorithm may be used for clustering user scores. In one example, the K-means clustering algorithm is used on the user scores to split users into influential and non-influential users by applying a K-means clustering with Expectation Maximization on the one-dimensional vector of user scores. In some implementations, before splitting the vector (e.g., into influential and non-influential users), one or more users may be removed. For example, in some examples, before splitting, users with small or no social activity or specific activity (e.g., non-post or non-comment users) may be trimmed. Similarly, the social property owner may be removed. In other examples, where certain users have a score above a certain threshold and/or over a certain period or otherwise have characteristics that designates the users as highly influential, the users may be designated as influential users by ratio first. In one example, the clustering algorithm may perform trimming and/or confirmation steps until the center points adjustment is below a certain threshold.

Once, in step 204, influential users are determined, the process continues to step 205. In step 205, an indication of influential users for the social property is provided for display. For example, in one implementation, a listing of influential users and/or scores for the influential users is provided for display. In one example, the influential users are provided with a special icon or other indicator. In some examples, other indicia of a user being an influential user may be provided. For example, the determination or indicia may be used to filter influential users.

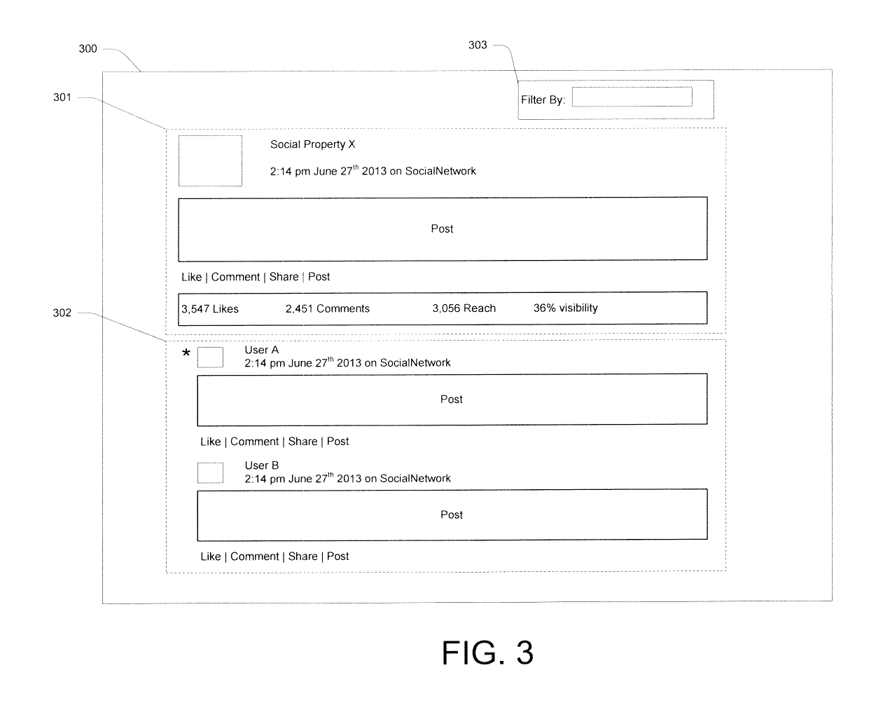

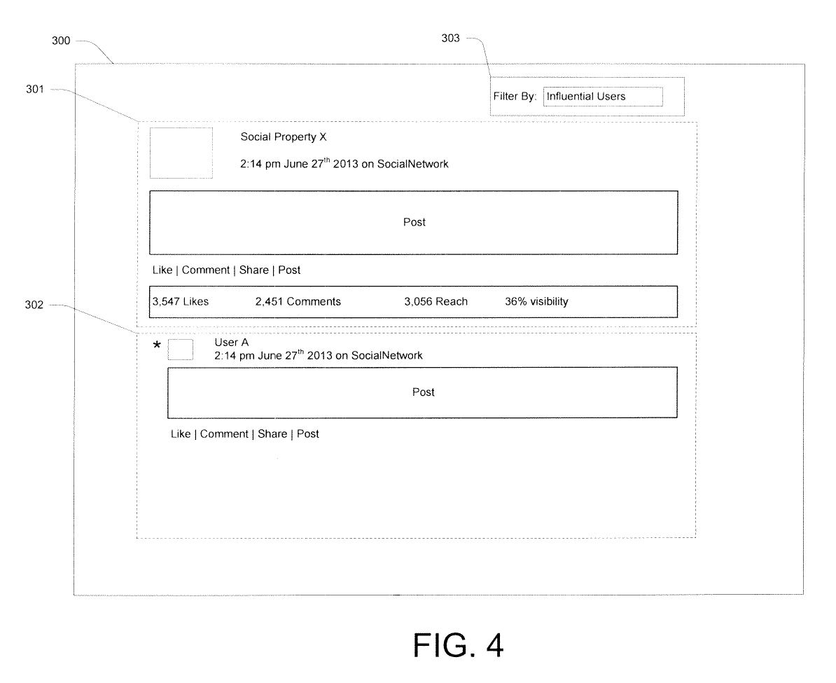

FIGS. 3 and 4 illustrate an example graphical user interface displaying influential user information with respect to a social property. As shown in FIG. 3, user interface 300 may display a social property area 301 displaying one or more social activity of a social property. For example a “post” associated with the social property X is displayed within the area 301. Information regarding activity with respect to the post and/or other social activity of the social property is also displayed (e.g., showing likes, comments, reach and visibility of the post). A user area 302 displays one or more users associated with the social property and taking action with respect to the social property social activity. A first user A is shown with an asterisk which indicates that the user is an influential user, while a second user B is shown without an indication of being an influential user. In one example, user interface 300 may provide the user with a filter mechanism 303 for filtering users displayed within the user area 302. For example, in one example, the filtering may allow the social property owner to filter by influential user status. As shown in FIG. 4, the influential user entry is entered at the filter mechanism 303. In response to the filtering request, the users shown within user area 302 have been filtered, such that only user A, identified as an influential user is being displayed with the user area 302.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

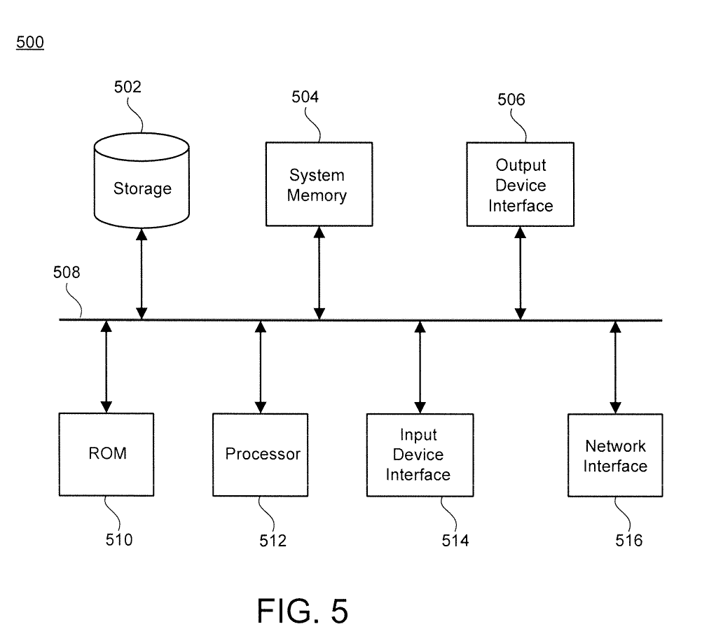

FIG. 5 conceptually illustrates an electronic system with which some implementations of the subject technology are implemented. Electronic system 500 can be a server, computer, phone, PDA, laptop, tablet computer, television with one or more processors embedded therein or coupled thereto, or any other sort of electronic device. Such an electronic system includes various types of computer readable media and interfaces for various other types of computer readable media. Electronic system 500 includes a bus 508, processing unit(s) 512, a system memory 504, a read-only memory (ROM) 510, a permanent storage device 502, an input device interface 514, an output device interface 506, and a network interface 516.

Bus 508 collectively represents all system, peripheral, and chipset buses that communicatively connect the numerous internal devices of electronic system 500. For instance, bus 508 communicatively connects processing unit(s) 512 with ROM 510, system memory 504, and permanent storage device 502.

From these various memory units, processing unit(s) 612 retrieves instructions to execute and data to process in order to execute the processes of the subject disclosure. The processing unit(s) can be a single processor or a multi-core processor in different implementations.

ROM 510 stores static data and instructions that are needed by processing unit(s) 512 and other modules of the electronic system. Permanent storage device 502, on the other hand, is a read-and-write memory device. This device is a non-volatile memory unit that stores instructions and data even when electronic system 500 is off. Some implementations of the subject disclosure use a mass-storage device (such as a magnetic or optical disk and its corresponding disk drive) as permanent storage device 502.

Other implementations use a removable storage device (such as a floppy disk, flash drive, and its corresponding disk drive) as permanent storage device 502. Like permanent storage device 502, system memory 504 is a read-and-write memory device. However, unlike storage device 502, system memory 504 is a volatile read-and-write memory, such a random access memory. System memory 504 stores some of the instructions and data that the processor needs at runtime. In some implementations, the processes of the subject disclosure are stored in system memory 504, permanent storage device 502, and/or ROM 510. For example, the various memory units include instructions for identifying influential users with respect to social property according to various implementations. From these various memory units, processing unit(s) 512 retrieves instructions to execute and data to process in order to execute the processes of some implementations.

Bus 508 also connects to input and output device interfaces 514 and 506. Input device interface 514 enables the user to communicate information and select commands to the electronic system. Input devices used with input device interface 514 include, for example, alphanumeric keyboards and pointing devices (also called “cursor control devices”). Output device interfaces 506 enables, for example, the display of images generated by the electronic system 500. Output devices used with output device interface 506 include, for example, printers and display devices, such as cathode ray tubes (CRT) or liquid crystal displays (LCD). Some implementations include devices such as a touchscreen that functions as both input and output devices.

Finally, as shown in FIG. 5, bus 508 also couples electronic system 500 to a network (not shown) through a network interface 516. In this manner, the computer can be a part of a network of computers (such as a local area network (“LAN”), a wide area network (“WAN”), or an Intranet, or a network of networks, such as the Internet. Any or all components of electronic system 500 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that some illustrated steps may not be performed. Some of the steps may be performed simultaneously. For example, in certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, where reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

1. A machine-implemented method comprising:
identifying a plurality of users that access a social property over one or more computer networks;
for each of the plurality of users calculating, by a server, an influence score for the user with respect to the social property, wherein the influence score for the user is calculated based at least in part on one or more social activities performed by the user on the social property and a first quantity of first social activity performed by one or more contacts of the user on the social property relative to a second quantity of other social activity performed by the one or more contacts of the user on the social property, wherein the first social activity is directed to the user and at least some of the other social activity is directed to at least one other user of the plurality of users associated with the social property;
determining, by the server, a set of users of the plurality of users, the set of users including one or more users, having the influence score that meets a condition indicating that the user is an influential user; and
providing, by the server and to a client device, an indication of the set of users being influential users for display to surface activity from only the influential users of the plurality of users that access the social property over the one or more computer networks.

2. The method of claim 1, wherein the social property comprises content associated with a social entity.

3. The method of claim 2, wherein the social entity is one of an individual, brand, business, category, or grouping defined by a set of criteria.

4. The method of claim 3, wherein the social property is defined as content associated with or meeting the set of criteria.

5. The method of claim 1, wherein the influence score is defined by component values, each of the component values corresponding to a different respective feature.

6. The method of claim 5, wherein each respective feature represents a different type of social activity, the different types of social activity comprising at least two of: endorsing, commenting, sharing, posting, or resharing.

7. The method of claim 6, wherein each respective component value corresponding to each respective feature is defined by a respective feature matrix multiplied by a respective feature parameter.

8. The method of claim 7, wherein each respective feature parameter is defined based on an importance weight of each respective feature.

9. The method of claim 7, wherein each respective element of each respective feature matrix of each respective feature comprises a value that contributes to the influence score of the user, the value being defined by relationship between the user and each respective contact of the one or more contacts of the first user with respect to the different type of social activity represented by the respective feature.

10. The method of claim 5, wherein the influence score of each user is updated iteratively, and wherein each component of the influence score is dependent on a score of the user during a previous iteration.

11. The method of claim 1, wherein calculating the influence score for the user with respect to the social property comprises normalizing the calculated influence score for the user with respect to the social property.

12. The method of claim 11, wherein the normalizing is done by standard deviation.

13. The method of claim 1, wherein determining the set of users comprises clustering the users into two sets, including a first set comprising the set of users, and a second set comprising non-influential users.

14. The method of claim 13, wherein the clustering is performed using a K-means clustering algorithm.

15. The method of claim 1, further comprising:
collecting data regarding the plurality of users across one or more social networking services; and
generating a social graph for each of the plurality of users according to social graph data of the data collected across the one or more social networking services, wherein the one or more contacts of each user of the plurality of users is defined based on the social graph for the user.

16. The method of claim 15, wherein the data collected across the one or more social networking services further comprises social activity data for the plurality of users and the one or more contacts of each of the plurality of users, and wherein the influence score of the user is determined based on the data collected across the one or more social networking services.

17. The method of claim 1, further comprising:
providing a mechanism for filtering the plurality of users according to being influential users; and
filtering the plurality of users according to the influence score for each of the plurality of users in response to receiving a request through the mechanism.

18. The method of claim 1, wherein the indication comprises an icon being displayed with respect to the set of users being influential users.

19. A system comprising:
one or more processors; and
a machine-readable medium comprising instructions stored therein, which when executed by the processors, cause the processors to perform operations comprising:
identifying a plurality of users that access a social property over one or more computer networks;
for each of the plurality of users determining an influence score for the user with respect to the social property, wherein the influence score for the user is defined with respect to a first social activity of one or more contacts of the user with respect to the social property relative to other social activity of the one or more contacts of the user with respect to the social property, the first social activity being associated with the user and the other social activity being at least partially different than the first social activity, the influence score being defined in terms of one or more feature component values, and each feature component value corresponding to a different type of social activity;
determining a set of influential users of the plurality of users, the set of influential users including one or more users having the influence score that meets a condition indicating that the user is an influential user; and
providing an indication identifying the set of influential users for display to surface only the influential users from the plurality of users that access the social property over the one or more computer networks.

20. A non-transitory machine-readable medium comprising instructions stored therein, which when executed by a machine, cause the machine to perform operations comprising:
identifying a plurality of users that access a social property over one or more computer networks;
for each of the plurality of users determining an influence score for the user with respect to the social property, wherein the influence score for the user is defined with respect to social activity of one or more contacts of the user that is associated with the user relative to other social activity of the one or more contacts of the user, the influence score being defined in terms of different feature component values, each different feature component value representing a contribution to the influence score by one of a plurality of different types of social activity of the user;
normalizing the influence score for each of the plurality of users;
clustering the plurality of users into two sets according to the normalized influence score for each of the plurality of users;
determining a first set of the two sets of clusters as a set of influential users of the plurality of users according to the clustering; and
providing an indication that the set of influential users are influential users to surface activity of the influential users from activity of the plurality of users that access the social property over the one or more computer networks.

21. (canceled)

22. The non-transitory machine-readable medium of claim 20, wherein the plurality of different types of social activity of the user comprise two or more of: endorsing, commenting, sharing, posting, or resharing.
